(19) United States
(12) Patent Application Publication
(10) Pub. No.: US 2026/0349087 A1
(43) Pub. Date: Nov. 5, 2026

(54) Scanning device and method for spatial measurement of an environment

(71) Applicant: SICK AG, Waldkirch (DE)

(72) Inventor: Georg SCHNEIDER, Hamburg (DE)

(21) Appl. No.: 19/529,417

(22) Filed: Feb. 4, 2026

(30) Foreign Application Priority Data
Feb. 13, 2025 (DE) 102025105485.1

(51) Int. Cl. G01S 7/481; G01S 17/89

(52) U.S. Cl. CPC G01S 7/4817; G01S 17/89

(57) ABSTRACT

The present invention relates to a scanning apparatus (100) for a spatial measurement of an environment (200) and to a method for a spatial measurement of an environment (200) by the scanning apparatus (100), the scanning apparatus (100) comprising a LiDAR sensor unit (10) having a light source for transmitting transmission light (20) into the environment (200), a reception unit (12) for receiving transmission light (20) remitted and/or reflected in the environment (200) as reception light (22), and an evaluation unit (14), wherein the evaluation unit (14) is configured to evaluate the LiDAR data (70) determined by the reception unit (12) for the spatial measurement of the environment (200). The invention further relates to a method for a spatial measurement of an environment (200) by such a scanning apparatus (100).

The invention relates to a scanning apparatus for a spatial measurement of an environment, said scanning apparatus comprising a LiDAR sensor unit having a light source for transmitting transmission light into the environment, a reception unit for receiving transmission light remitted and/or reflected in the environment as reception light, and an evaluation unit, wherein the evaluation unit is configured to evaluate the LiDAR data determined by the reception unit for the spatial measurement of the environment.

A monitoring of an environment, for example for an obstacle recognition by autonomously driving vehicles, is usually based on a spatial measurement of at least a section of the environment. LiDAR (light detection and ranging) sensor units are often used as the scanning apparatus for this purpose. Objects in the environment, in particular obstacles, are in this respect recognized via a transmitted light signal, usually laser light, and a corresponding reception of portions of this light signal that are remitted and/or reflected in the environment. For the measurement of the environment, distances from the individual locations of the remission or reflection in the environment are then determined via an evaluation of the received light signals, in particular of times of flight of the light signals.

The transmission light, in particular if it is laser light, is usually present as a light beam with a small beam cross-section. In the near zone, which e.g. extends between a distance of up to 2 meters from the scanning apparatus, there is, however, the problem that the time of flight of the light signals is in the order of magnitude of the used pulse widths of the transmitted light signals, whereby an accurate distance measurement is made more difficult.

Based on the known scanning apparatus described above, it is therefore the object of the present invention to improve scanning apparatus of the prior art. In particular, it is the object of the present invention to provide a scanning apparatus that enables an improved measurement of an environment in the near zone.

The object is satisfied according to the invention by a scanning apparatus according to the independent claim 1. The object of the invention is further satisfied by a method according to claim 15. Further developments of the scanning apparatus according to the invention result from the dependent claims, from the description, and from the drawings.

According to the invention, the object is satisfied by a scanning apparatus for a spatial measurement of an environment, said scanning apparatus comprising a LiDAR sensor unit having a light source for transmitting transmission light into the environment, a reception unit for receiving transmission light remitted and/or reflected in the environment as reception light, and an evaluation unit, wherein the evaluation unit is configured to evaluate the data determined by the reception unit for the spatial measurement of the environment. The scanning apparatus according to the invention is characterized in that the LiDAR sensor unit has an optical sensor arrangement that is rotatably supported about an axis of rotation and that has two sensor sections, wherein the sensor sections are spaced apart from one another and are arranged at different positions with respect to the axis of rotation, wherein a first of the sensor sections is formed by optically sensitive elements of the reception unit and determines the LiDAR data, wherein furthermore a second of the sensor sections (44) determines optical environmental data, and wherein the evaluation unit is configured to evaluate the environmental data and is further configured to determine stereo 3D data based on the LiDAR data and the environmental data in order to improve the spatial measurement of the environment.

The invention is based on the realization that, due to the detection of the environment by means of the two sensor sections, it is possible to detect the environment from two different perspectives, wherein distance information or depth information can be obtained from the two perspectives by means of stereoscopic methods. The distance information or depth information obtained by means of stereoscopy can then serve to improve the distance information or depth information of the LiDAR sensor unit, i.e., for example, to correct, validate and/or replace said information. The distance information or depth information obtained by means of stereoscopy is referred to herein as stereo 3D data, wherein the LiDAR data determined by the reception unit or the first sensor section and the environmental data determined by the second sensor section are preferably included in the stereo 3D data, at least in part in each case.

The scanning apparatus according to the invention preferably has the usual components of a LiDAR sensor unit. A light source, in particular a laser source, provides a transmission light, in particular in the form of a laser beam, that is radiated into the environment to be measured. This preferably takes place by scanning the environment to be measured with the transmission light, for example, by rotating the entire light source or elements of the light source, for example a deflection mirror. Since a rotational position of the light source is known for each point in time, the transmission light can be continuously and/or discretely transmitted with a known angular correlation into the environment in this way. The rotation can take place continuously with the same direction of rotation but also in an oscillating manner with a constantly changing direction of rotation.

The transmitted transmission light is incident in the environment on objects that can be located at different distances from the scanning apparatus according to the invention. The transmission light is remitted or reflected by these objects. This remission and/or reflection of the transmission light can at least partly take place in the direction of the scanning apparatus according to the invention and can then be registered therein as reception light by the reception unit.

The information determined by the reception unit, for example a time of flight of the received reception light, is referred to as LiDAR data in the sense of the invention and is evaluated by the evaluation unit. Since, as described above, the transmission light is transmitted with a known angular correlation into the environment, the reception light can also have a correspondingly likewise known angular correlation with respect to the environment. This can be considered in the evaluation by the evaluation unit and a measurement of the environment, i.e. in particular a determination of the distances of objects in the environment from the scanning apparatus, can thereby take place.

The scanning apparatus according to the invention is characterized in that the evaluation performed by the evaluation unit for measuring the environment is improved by consulting further information. To provide this information, the LiDAR sensor unit of the scanning apparatus according to the invention has an optical sensor arrangement that is rotatably supported about an axis of rotation and that has two sensor sections. A sensor section in the sense of the invention is in particular a component that is optically sensitive and that is thus configured to acquire optical information, for example a CMOS sensor or a CCD sensor, but also already a simple (avalanche) photodiode, a photomultiplier or a photoresistor.

Furthermore, a first of the two sensor sections is formed by optically sensitive elements of the reception unit. In other words, the first sensor section is part of the LiDAR sensor unit that has already been described above and that is used for a basic measurement of the environment. In particular, the LiDAR data on which the measurement of the environment made possible by the LiDAR sensor unit is based are determined by the first sensor section.

In addition to the first sensor section, the sensor arrangement of the scanning apparatus according to the invention has a further, second sensor section. Said second sensor section is also configured to determine information based on optical signals from the environment, referred to as environmental data in the sense of the invention. The two sensor sections can be designed identically or differently in their technical realization. In particular, provision can preferably be made that the two sensor sections are readable separately from one another. The two sensor sections can furthermore be read at the same time or also offset in time.

An arrangement of the two sensor sections in the sensor arrangement is provided such that the two sensor sections are arranged spaced apart from one another. In particular, the two sensor sections, also due to their spaced-apart arrangement described above, are positioned at different positions, in particular at different distances, with respect to the axis of rotation of the sensor arrangement.

In other words, due to this spaced-apart arrangement from one another and due to the different positions with respect to the axis of rotation, it can be ensured that the two sensor sections observe different regions, in particular angular regions, in the environment or are sensitive to optical signals from different regions of the environment. It can thus be achieved that the LiDAR data and the environmental data, which are each determined by one of the two sensor sections, are different.

In particular, each of the two sensor sections has its own detection zone. In other words, the detection zones differ and are in particular not congruent. Preferably, the respective detection zone can extend along a viewing direction or sensor axis of the corresponding sensor section, i.e. can be arranged and oriented along this viewing direction.

As already explained, the sensor arrangement is rotatably supported about an axis of rotation in the LiDAR sensor unit and/or the entire scanning apparatus according to the invention. During an operation of the scanning apparatus according to the invention, the two sensor sections thus also rotate about the axis of rotation. It can thus be achieved that the two detection zones of the sensor sections also rotate and thereby sweep over different regions of the environment in the course of the rotation.

Preferably, the rotation of the sensor arrangement can be adapted to, in particular synchronized with, the above-described scanning process of the light source. Since the first sensor section is part of the LiDAR sensor unit as described above, it can be ensured in this way that the first sensor section can fulfill its function as an optically sensitive element of the reception unit. Preferably, the first sensor section is positioned in the sensor arrangement and its rotation is adapted to the scanning process of the light source such that the angular region of the environment that is illuminated by the light source can be at least partly, in particular completely, observed by the first sensor section.

At the same time, it can be achieved by the rotation of the sensor arrangement that the same region in the environment can be measured by each of the two sensor sections, namely at a first angle of rotation by the first sensor section and at a second angle of rotation by the second sensor section. In other words, a region in the environment that is measured by the first sensor section at a first point in time of the rotation or in a first rotational position of the sensor arrangement can be measured by the second sensor section at a second point in time of the rotation or in a second rotational position of the sensor arrangement if the sensor arrangement has continued to rotate accordingly.

In this way, it can be achieved that both LiDAR data determined by the first sensor section and environmental data determined by the second sensor section are available for the region of the environment to be measured. Since, on the one hand, the two sensor sections, as described above, have different and in particular differently oriented reception zones and, on the other hand, at different angles of rotation of the sensor arrangement, are sensitive for a respective section of the region of the environment to be measured, the corresponding LiDAR data and environmental data are recorded from different perspectives for each section of the region of the environment to be measured. LiDAR data or environmental data that originate from the same object in the environment are in particular different, for example, due to an at least slightly different viewing angle of the two sensor sections on the corresponding object. In this way, in the evaluation performed by the evaluation unit, stereographic projection methods can be used to determine stereo 3D data.

Depending on the distance of an object in the environment, an offset of the LiDAR data or environmental data corresponding to this object and determined by the two sensor sections changes. From this offset and the known properties of the scanning apparatus according to the invention, in particular the position and orientation of the sensor sections and their respective reception zone, stereo 3D data can be obtained that, for example, indicate and/or comprise a distance of the respective object from the scanning apparatus according to the invention. In particular, the evaluation unit is configured, by means of this additional information provided by the stereo 3D data, to improve the spatial measurement of the environment that is made possible solely by the usual elements of the LiDAR sensor unit.

The stereo 3D data determined in this way can in particular comprise distances of objects or independently identifiable sections of objects, such as corners, edges or the like. These stereo distances obtained from the stereo 3D data are further in particular available in addition to the LiDAR distances determined purely by the LiDAR sensor unit. An improvement of the measurement of the environment can thus in particular take place in that, for objects or sections of objects for which values of both distance determinations are available in each case, a distance actually output as the result of the measurement is determined based on both determined raw distance values, i.e. the respective values of the LiDAR distance and the stereo distance.

For the improvement of the measurement, a, possibly weighted, mean value can, for example, be calculated from corresponding LiDAR distances and stereo distances. The LiDAR distances can accordingly be corrected using corresponding stereo distances. During the determination, a plausibility check can, for example, also take place as to whether a value of a determined LiDAR distance matches the value of an associated determined stereo distance at least within a defined error tolerance.

The improvement of the spatial measurement can also comprise replacing determined values of LiDAR distances with values of correspondingly determined stereo distances.

In this respect, the improvement can respectively take place for individual distance values, for distance values for an entire object, or for all distance values.

The evaluation unit can also be configured to perform the improvement, in particular only, if a signal strength (of the reception light) and/or a ratio of a measurement signal to noise (SNR—signal to noise ratio) (of the reception light) in the reception unit of the LiDAR sensor unit falls below a predetermined threshold value. Alternatively or additionally, the evaluation unit can also be configured to perform the improvement, in particular only, if a signal strength (of the reception light) in the reception unit of the LiDAR sensor unit falls below a predetermined threshold value.

In particular, an exceeding of a certain signal strength and a falling below of a certain SNR indicate that the LiDAR sensor unit is performing a measurement in the near zone that can be easily improved by the stereo 3D data.

Further alternatively or additionally, the evaluation unit can also be configured to perform the improvement, in particular only, if a LiDAR distance determined by the LiDAR sensor unit and/or a stereo distance obtained in the stereo 3D data exceeds a predetermined distance threshold value. The distance threshold value can, for example, amount to 5 m, 3 m, 2 m or 1 m. In this way, it can be recognized that a measurement takes place in the near zone, whereupon the improvement is then triggered.

The above-described offset of the LiDAR data or environmental data determined by the two sensor sections is in particular greater, the closer the correspondingly detected object in the environment is to the scanning apparatus according to the invention. Accordingly, the stereo 3D data determined by the evaluation unit are the more accurate and meaningful for objects close to the scanning apparatus, i.e. in the so-called near zone, than for objects further away. However, as explained above, the spatial measurement using pure LiDAR is less accurate in the near zone. In other words, the additionally possible determination and consideration of stereo 3D data in the scanning apparatus according to the invention in particular enables a near-field correction, i.e. an improvement of the spatial measurement in a region close to the scanning apparatus, in the sense of the invention, for example, in a distance range of 0 m to 1-2 m with respect to the scanning apparatus.

The scanning apparatus according to the invention comprising a sensor arrangement having two sensor sections was described above. However, the scanning apparatus according to the invention is not limited to this number of sensor sections. Thus, the corresponding sensor arrangement can also have three or more sensor sections, wherein, however, at least one pair of these three or more sensor sections has the above-described properties of the first and second sensor section.

Furthermore, the scanning apparatus according to the invention can be characterized in that respective viewing directions of the two sensor sections, along which the respective sensor section is sensitive, include an angle Δα, preferably an angle Δα between 15° and 45°. In this way, it can be ensured that the reception zones of the two sensor sections, which, as described above, can each extend along the viewing direction, are sufficiently different. Due to an angle Δα between these viewing directions, it can be particularly easily ensured that the two reception zones are different. An angle Δα between 15° and 45° has proven to be a particularly good compromise to provide the reception zones as sufficiently different, on the one hand, and not to require too large angles of rotation of the sensor arrangement, on the other hand, in order to detect the same region in the environment to be measured with both sensor sections.

Since the viewing directions include an angle Δα, the two viewing directions intersect. In this respect, it is preferred, on the one hand, that the two viewing directions are arranged together in a common viewing plane. On the other hand, it is alternatively or additionally preferred that the two viewing directions intersect in front of the sensor sections, i.e. in the direction of the environment to be measured. This, for example, enables a particularly compact design of the scanning apparatus.

According to a further development of the scanning apparatus according to the invention, it can further be provided that the viewing direction of at least one of the sensor sections is oriented transversely to the axis of rotation, preferably the viewing directions of both sensor sections are oriented transversely to the axis of rotation. Due to an orientation of the viewing direction of one or both sensor sections transversely to the axis of rotation, a particularly clear and simple geometric determination of the reception zone of the corresponding sensor section in the environment to be measured can be achieved. A reconstruction of this reception zone during the evaluation of the measurement data determined by the respective sensor section by the evaluation unit can thereby be facilitated.

The scanning apparatus according to the invention can also be further developed in that the two viewing directions each sweep over a sensor region during the rotational movement of the sensor arrangement, with the two sensor regions overlapping to form a scanning zone of the scanning apparatus of 60°, in particular 180°, preferably 360°. Each of the two sensor sections sweeps over a sensor region in the environment with its viewing direction and, in this sensor region, data, i.e. LiDAR data or environmental data, can be determined by the respective sensor section. The scanning zone as the overlapping region of the two sensor regions therefore represents that part of the environment for which both LiDAR data and environmental data are available. For this scanning zone, the measurement of the environment based on the LiDAR data determined by the first sensor section can thus be improved by the stereo 3D data determined while additionally using the environmental data of the second sensor section.

A scanning zone of 60° in particular makes it possible to measure an environment in front of the scanning apparatus in an improved manner, for example, to recognize objects in the direction of travel of a vehicle. Larger scanning zones, for example 180°, enable a better overview of the environment, wherein a scanning zone of 360° provides an all-round view.

Furthermore, the scanning apparatus according to the invention can be configured such that, during the rotational movement of the sensor arrangement, the two sensor sections each determine a plurality of individual recordings as LiDAR data and environmental data, with the evaluation unit being configured to generate a first input image from the individual recordings of the first sensor section and to generate a second input image from the individual recordings of the second sensor section, and wherein the evaluation unit is configured to generate an output image from the first input image and the second input image. In other words, during the rotational movement of the sensor arrangement, data are determined for different angular positions in each case, in particular an individual recording is recorded for each of these angular positions. Preferably, it can be provided that the respective reception zones of the sensor sections and an angular increment between the individual angular positions are matched to one another such that the regions of the environment that are photographed in the individual recordings are free of overlap.

Due to a joint review of the individual recordings that is generated by the evaluation unit, an input image of the entire sensor region of the respective sensor section then results. Due to the individual recordings, this input image can in particular be provided without having to generate an image of the entire sensor region for each rotational position of the sensor arrangement.

In particular, the input image of the first sensor section can here represent or comprise LiDAR data, in particular the determined LiDAR distances. Depending on the design of the second sensor section, the input image of the second sensor section can, for example, comprise a one-dimensional or two-dimensional image of the environment.

An output image is then generated from the two input images of the two sensor sections by the evaluation unit. For this purpose, the information of these two input images is used to generate the output image in that rotation angle range in which both input images are available. As a result, the output image can preferably be generated in particular for the above-described scanning zone of the scanning apparatus according to the invention.

There are various options for generating the output image. For example, an image of the environment provided by the input image of the second sensor section can be supplemented by an additional display of LiDAR distances based on the LiDAR data of the first sensor section. Furthermore, a display of stereo distances, which are determined, as already stated above, by an evaluation based on both the LiDAR data of the first sensor section and the environmental data of the second sensor section, in the input image of the second sensor section as the output image is also conceivable. In particular, the output image can also comprise the improvement of the measurement of the environment already described above, in which in particular distances from objects in the environment are improved by a joint review of LiDAR distances and stereo distances.

The examples described above do not represent an exhaustive description of the possible designs of the output image.

Both the input images and the output image can be available in an exclusively computer-readable form. In addition, a human-readable display of the input images and/or the output image can also be generated, for example, for a display on a monitor or data glasses.

The scanning apparatus according to the invention can also be further developed such that the output image comprises the measurement of the environment that is improved by the determined stereo 3D data, preferably such that the output image corresponds to the measurement of the environment that is improved by the determined stereo 3D data. According to this further development, by considering both sensor sections, the output image thus includes the improved spatial measurement and preferably even includes it exclusively. Once again, the output image can here preferably be generated in particular for the above-described scanning zone of the scanning apparatus according to the invention. In other words, as a result of an operation of the scanning apparatus according to the invention, output images are obtained in which a spatial measurement of the environment that is improved by stereo 3D data is depicted.

Furthermore, the scanning apparatus according to the invention can be further developed such that the scanning apparatus has an output interface for outputting the first input image and/or the second input image and/or the output image, said output interface communicating data with the evaluation unit. Due to such an output interface, a forwarding and/or playback of the input images or the output image can be made possible. An output interface in the sense of the invention can already be a plug-in connection for a correspondingly provided data line. Preferably, an output interface can, however, also comprise an actual optical representation of the respective image, for example, by a design of the output interface as a display or as data glasses.

In addition, the scanning apparatus according to the invention can be characterized in that an optically sensitive region of the two sensor sections corresponds to a single picture element in each case. Such a picture element can also be called a pixel. Preferably, a limited region of the environment is observed by the corresponding sensor section, in particular a region directly around the viewing direction of the sensor section. In the embodiment described above, in which a plurality of individual images are recorded during the rotational movement of the sensor arrangement, a line image of the environment is in this respect produced both for the input images of the two sensor sections and for the output image.

Alternatively, provision can be made in the scanning apparatus according to the invention that an optically sensitive region of the two sensor sections corresponds to a column of picture elements in each case, with the picture elements being arranged along a longitudinal extent in the column, and with the longitudinal extent of the respective column preferably being aligned parallel to the axis of rotation of the sensor arrangement. Now, in the embodiment described above, in which a plurality of individual images are recorded during the rotational movement of the sensor arrangement, a two-dimensional image in the environment is produced both for the input images of the two sensor sections and for the output image in each case.

Furthermore, the scanning apparatus according to the invention can also be configured such that the second sensor section is configured as a component of one of the following sensor units:
component of a LiDAR sensor unit
component of a background light measurement unit.

This list is not exhaustive and other sensor units are in particular also conceivable as the basis for the second sensor section.

The LiDAR sensor unit, whose component is the second sensor section, can in this respect be that LiDAR sensor unit which already comprises the first sensor section, or it can also be a completely independent LiDAR sensor unit. In this design of the scanning apparatus according to the invention, the environmental data of the second sensor section are therefore also available as LiDAR data. Thus, using LiDAR data of both sensor sections, respective distances of objects in the environment can be determined that then together, for example by the averaging or plausibility check methods already described above, enable an overall improvement in the measurement of the environment.

A background light measurement unit can in turn comprise a camera chip of an electronic camera, for example. In this embodiment of the scanning apparatus according to the invention, LiDAR distances from objects in the environment can be determined via the first sensor section as part of the LiDAR sensor unit. The second sensor section enables the capture of the environment as a 2D image, wherein stereo distances can then be determined by stereography based on the different viewing angles of the two sensor sections, as already explained above. In this embodiment, an improvement of the measurement of the environment is also made possible overall, for example, by the averaging or plausibility check methods already described above.

The scanning apparatus according to the invention can also be characterized in that the sensor sections are arranged vertically spaced apart from one another parallel to the axis of rotation of the sensor arrangement. In other words, if the two sensor sections measure the same region in the environment, an additional difference in the viewing angle at which the respective sensor section measures the environment results from the height difference that results from the vertical spacing apart of the two sensor sections parallel to the axis of rotation. This additional difference in the viewing angle can be considered in the evaluation by the evaluation unit to further increase the improvement of the spatial measurement of the environment.

Furthermore, the scanning apparatus according to the invention can be configured such that the sensor arrangement has an optical sensor element, with the sensor sections being configured as sections of the sensor element that are geometrically spaced apart from one another, or in that the sensor arrangement has two geometrically separate optical sensor elements, with each sensor element comprising one of the sensor sections.

In this embodiment of the scanning apparatus according to the invention, it can be provided, on the one hand, that only a single optical sensor element is used to provide both sensor sections. In this way, double evaluation electronics can be omitted, for example. This can be advantageous in particular for embodiments in which the two sensor sections are technically identical or are identically constructed.

Alternatively, provision can be made to provide each of the two sensor sections with their own, separate sensor element. In particular, it can thereby be made possible to use a separate, technically different sensor element for each of the two sensor sections. A particularly variable design of a sensor arrangement for the scanning apparatus according to the invention, which design can be adapted to a wide range of requirements, can hereby be made possible.

In both designs, the sensor elements used can be provided as discrete components or integrated components, in particular fully integrated components.

The scanning apparatus according to the invention can also be characterized in that the sensor arrangement has a common sensor optics for the sensor sections, or in that the sensor arrangement has a separate sensor optics for each of the sensor sections. The environment to be measured, in particular that region of the environment which can be measured by the reception zone of the respective sensor section, is imaged onto the corresponding sensor section by the sensor optics. A single, common sensor optics in particular enables the entire sensor arrangement to be designed particularly compactly. On the other hand, two separate sensor optics can be used to enable an adapted and needs-based imaging of the environment for each of the two sensor sections.

Furthermore, the scanning apparatus according to the invention can be characterized in that the sensor sections are positioned at different sides of the axis of rotation, preferably in that the sensor sections are positioned symmetrically with respect to the axis of rotation. As already explained above, the determination of the stereo 3D data is in particular based on a difference in the viewing angle of the two sensor sections on the environment to be measured. By arranging the two sensor sections on different sides with respect to the axis of rotation, a particularly large distance between the sensor sections can be achieved with constant external dimensions of the scanning apparatus according to the invention. A symmetrical arrangement of the two sensor sections in turn enables a simplification of the evaluation of the determined LiDAR data and environmental data.

The object is further satisfied by a method for a spatial measurement of an environment, wherein the method according to the invention is carried out by a scanning apparatus according to the invention. The method according to the invention is characterized in that LiDAR data are acquired by the LiDAR sensor unit of the scanning apparatus and a spatial measurement of the environment is performed based on these LiDAR data, with optical environmental data of the environment additionally being acquired by the second sensor section of the scanning apparatus and stereo 3D data being determined by the evaluation unit of the scanning apparatus based on the LiDAR data and these additional environmental data of the second sensor section, and wherein the measurement of the environment is improved by the evaluation unit by considering these stereo 3D data.

The method according to the invention is carried out by the scanning apparatus according to the invention. All the features and advantages that were described above with respect to the scanning apparatus according to the invention can thus also be made possible by the method according to the invention.

In the following, embodiments of the scanning apparatus according to the invention are described by way of example with reference to schematic figures. There are shown in detail

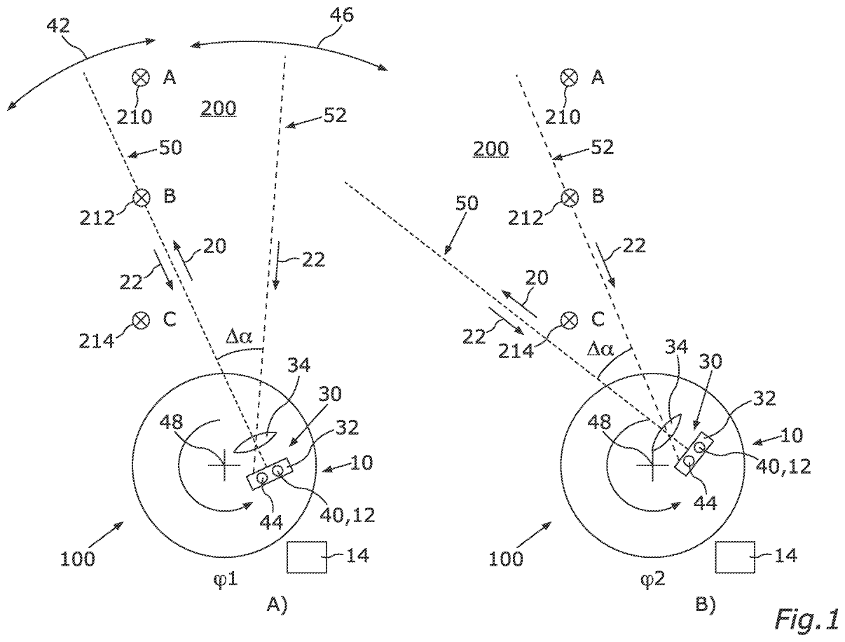

FIG. 1 a scanning apparatus according to the invention when scanning an environment; and

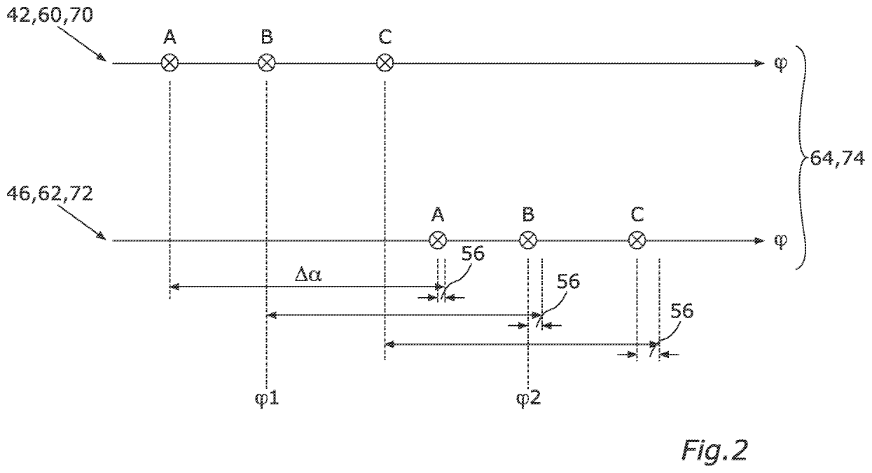

FIG. 2 a representation of the LiDAR data or environmental data determined in FIG. 1 by the scanning apparatus according to the invention.

A scanning apparatus 100 according to the invention and its mode of operation are schematically illustrated by means of FIGS. 1, 2. In this respect, the scanning apparatus 100 according to the invention is particular configured to perform the method according to the invention. FIGS. 1 and 2 are therefore described together in the following. The scanning apparatus 100 according to the invention is shown while spatially measuring an environment 200 in which three objects 210, 212, 214 are present.

The scanning apparatus 100 according to the invention in particular has a LiDAR sensor unit 10 that is capable of a basic spatial measurement of the environment 200. For this purpose, the LiDAR sensor unit 10 has a light source, not shown, for transmitting transmission light 20, which is reflected in the environment 200, in particular at objects 210, 212, 214 present in the environment 200, or is remitted by said objects, and is then detected as reception light 22 by a reception unit 12, in particular the first sensor section 40, of the LiDAR sensor unit 10. An evaluation unit 14, which is likewise part of the LiDAR sensor unit 10, evaluates the LiDAR data 70 determined by the reception unit 12 (cf. FIG. 2) and provides the spatial measurement of the environment 200 as a result.

In particular in a near zone around the scanning apparatus 100 according to the invention, for example at a distance of up to 2 m around the scanning apparatus 100, a resolution of the LiDAR sensor unit 10 used reaches its limits, however. According to the invention, it is therefore provided to achieve an improvement in the spatial measurement of the environment 200 by means of further measurements.

The LiDAR sensor unit 10 in particular has a sensor arrangement 30 that is rotatably supported about an axis of rotation 48 in the LiDAR sensor unit 10 or the scanning apparatus 100. In addition to the first sensor section 40 already mentioned above, this sensor arrangement 30 has a further optically sensitive second sensor section 44, wherein, as already described, the first sensor section 40 is formed by optically sensitive elements of the reception unit 12. The second sensor section 44 can, for example, likewise be part of a further LiDAR sensor unit or alternatively part of a background light measurement unit.

As shown, the sensor arrangement 30 can have a single sensor element 32, wherein the two sensor sections 40, 44 are formed by spatially separated sections of the sensor element 32. Alternatively, but not shown, it is also possible for the sensor arrangement 30 to have two sensor elements 32, with each of the sensor elements 32 then forming one of the two sensor sections 40, 44.

A sensor optics 34 ensures that the incoming reception light 22 is appropriately focused for both sensor sections 40, 44. As shown, a common sensor optics 34 can be provided for both sensor sections 40, 44. Alternatively, a separate sensor optics 34 can also be installed for each of the two sensor sections 40, 44.

During the rotation of the sensor arrangement 30 (cf. the two partial figures A, B in FIG. 1), the first sensor section 40 determines LiDAR data 70 and the second sensor section 44 determines environmental data 72 that are then processed by the evaluation unit 14 to form corresponding input images 60, 62 (cf. FIG. 2). Both sensor sections 40, 44 can have an optically sensitive region that corresponds to a single picture element. In this case, the input images 60, 62 correspond to a line in the environment 200. Alternatively, the optically sensitive regions can also be formed as a column of picture elements. In this case, a two-dimensional image of the environment 200 is then produced as the respective input image 60, 62. In the latter configuration, the column of picture elements can preferably be aligned parallel to the axis of rotation 48.

The two sensor sections 40, 44 are arranged spaced apart from one another in the sensor arrangement 30 and can preferably be read separately from one another. In addition to a horizontal distance, the two sensor sections 40, 44 can additionally also be positioned vertically spaced apart from one another parallel to the axis of rotation 48 in the sensor arrangement 30. The reading of the sensor sections 40, 44 can take place at the same time or offset in time.

In particular, as shown in FIG. 1, the two sensor sections 40, 44 are arranged at different positions with respect to the axis of rotation 48. An arrangement with respect to the axis of rotation 48 on one side of the axis of rotation 48 is shown, but an arrangement of the first sensor section 40 on one side and of the second sensor section 44 correspondingly on the other side of the axis of rotation 48 is also conceivable.

Due to the spaced-apart arrangement, the two sensor sections 40, 44 also have different viewing directions 50, 52 along which a reception zone of the respective sensor section 40, 44 extends in the environment 200. Preferably, an angle Δα between the viewing directions can be between 15° and 45°.

As already described above, the sensor arrangement 30 is rotatably supported about the axis of rotation 48. The viewing directions 50, 52 of the two sensor sections 40, 44 thereby sweep over different sensor regions 42, 46 in the environment 200. Preferably, the viewing directions 50, 52 of the two sensor sections 40, 44 are oriented transversely to the axis of rotation 48. In FIG. 1, the sensor arrangement 30 is shown in two different rotational positions in the partial figures A and B. In an overlapping region, not shown, of the two sensor regions 42, 46, both LiDAR data 70 of the first sensor section 40 and environmental data 72 of the second sensor section 44 are thus available. This overlapping region represents a scanning zone of the scanning apparatus 100 according to the invention in which the spatial measurement of the environment 200 made possible solely based on the LiDAR data of the LiDAR sensor unit 10 can be improved by considering the environmental data 72 determined by the second sensor section 44. Preferably, the scanning zone can cover at least 60°, but a larger range, for example 180° or even 360°, can particularly preferably also be covered by the scanning zone.

The improvement in the measurement of the environment 200 made possible according to the invention is in particular based on the different viewing directions 50, 52, as described above, of the two sensor sections 40, 44 or on the different positions of the sensor sections 40, 44. A possible procedure for the corresponding evaluation is shown in FIG. 2. The evaluation is performed by the evaluation unit 14 that is configured accordingly.

In FIG. 2, input images 60, 62 are schematically shown, wherein the first input image 60 is formed from the LiDAR data 70 of the first sensor section 40 and thus depicts the sensor region 42 monitored by the first sensor section 40. Accordingly, the second input image 62 is formed from the environmental data 72 of the second sensor section 44 and depicts the sensor region 46 monitored by the second sensor section 44. It is clearly recognizable that both sensor sections 40, 44 detect the objects 210, 212, 214 present in the environment 200, but, due to their different positioning within the sensor arrangement 30, at different rotational positions φ of the sensor arrangement 30. The difference here is substantially determined by the angle Δα between the respective viewing directions 50, 52 of the sensor sections 40, 44. However, in particular depending on a distance of the respective object 210, 212, 214 from the scanning apparatus 100, an additional offset 56 occurs. The closer the respective object 210, 212, 214 is positioned in the environment 200 to the scanning apparatus 100, the greater this offset 56 is (cf. FIG. 1).

Stereo 3D data 74, for example stereo distances of objects 210, 212, 214, can now in particular be determined from this offset 56 and can be used for an improvement of the spatial measurement of the environment 200, such as is made possible solely by the LiDAR sensor unit 10. For example, values of LiDAR distances of objects 210, 212, 214, which are determined solely based on the LiDAR data 70 determined by the LiDAR sensor unit 10, can now be checked by the additionally available stereo distances. A check can be, for example, a plausibility check or the formation of a, possibly also weighted, mean value. An output image 64, which is generated by the evaluation unit 14 and which corresponds to the overlap of the two input images 60, 62 and thus to a corresponding overlap of the sensor regions 42, 46 of the two sensor sections 40, 44, can in this way represent a measurement of the environment 200 improved by the determined stereo 3D data 74, for example, in an output image 64 that comprises a two-dimensional image of the environment 200 based on the input image 62, which is formed from the environmental data 72 determined by the second sensor section 44, which two-dimensional image is supplemented by an additional, for example numerical, display of the stereo distances of objects 210, 212, 214, i.e. can contain depth information that can be more accurate than the depth information of the LiDAR data 70.

### REFERENCE NUMERALS

10 LiDAR sensor unit
12 reception unit
14 evaluation unit
20 transmission light
22 reception light
30 sensor arrangement
32 sensor element
34 sensor optics
40 first sensor section
42 sensor region (first sensor section)
44 second sensor section
46 sensor region (second sensor section)
48 axis of rotation
50 viewing direction (first sensor section)
52 viewing direction (second sensor section)
54 angle Δα
56 offset
60 first input image
62 second input image
64 output image
70 LiDAR data
72 environmental data
74 stereo 3D data
100 scanning apparatus
200 environment
210 object A
212 object B
214 object C

1. A scanning apparatus for a spatial measurement of an environment, said scanning apparatus comprising a LiDAR sensor unit having a light source for transmitting transmission light into the environment, a reception unit for receiving transmission light remitted and/or reflected in the environment as reception light, and an evaluation unit, wherein the evaluation unit is configured to evaluate the LiDAR data determined by the reception unit for the spatial measurement of the environment,
characterized in that
the LiDAR sensor unit has an optical sensor arrangement that is rotatably supported about an axis of rotation and that has two sensor sections,
wherein the sensor sections are spaced apart from one another and are arranged at different positions with respect to the axis of rotation (48),
wherein a first of the sensor sections is formed by optically sensitive elements of the reception unit and determines the LiDAR data,
wherein furthermore a second of the sensor sections determines optical environmental data,
and wherein the evaluation unit is configured to evaluate the environmental data and is further configured to determine stereo 3D data based on the LiDAR data and the environmental data in order to improve the spatial measurement of the environment.

2. The scanning apparatus according to claim 1,
wherein
the evaluation unit is configured to perform the improvement if a signal strength of the reception light and/or a ratio of a measurement signal to the noise of the reception light in the reception unit of the LiDAR sensor unit falls below a predetermined threshold value, and/or
if a signal strength of the reception light in the reception unit of the LiDAR sensor unit exceeds a predetermined threshold value, and/or
if a LiDAR distance determined by the LiDAR sensor unit and/or a stereo distance included in the stereo 3D data falls/fall below a predetermined distance threshold value.

3. The scanning apparatus according to claim 1,
wherein
respective viewing directions of the two sensor sections, along which the respective sensor section is sensitive, include an angle Δα.

4. The scanning apparatus according to claim 3,
wherein
the viewing direction of at least one of the sensor sections is oriented transversely to the axis of rotation.

5. The scanning apparatus according to claim 1,
wherein,
during the rotational movement of the sensor arrangement, the two sensor sections each determine a plurality of individual recordings as LiDAR data and environmental data, with the evaluation unit being configured to generate a first input image from the individual recordings of the first sensor section and to generate a second input image from the individual recordings of the second sensor section,
and wherein the evaluation unit is configured to generate an output image from the first input image and the second input image.

6. The scanning apparatus according to claim 5,
wherein
the output image comprises the measurement of the environment that is improved by the determined stereo 3D data.

7. The scanning apparatus according to claim 5,
wherein
the scanning apparatus has an output interface for outputting the first input image and/or the second input image and/or the output image, said output interface communicating data with the evaluation unit.

8. The scanning apparatus according to claim 1,
wherein
an optically sensitive region of the two sensor sections corresponds to a single picture element in each case.

9. The scanning apparatus according to claim 1,
wherein
an optically sensitive region of the two sensor sections corresponds to a column of picture elements in each case, with the picture elements being arranged along a longitudinal extent in the column.

10. The scanning apparatus according to claim 1,
wherein
the second sensor section is configured as a component of one of the following sensor units:
component of a LiDAR sensor unit
component of a background light measurement unit.

11. The scanning apparatus according to claim 1,
wherein the sensor sections are arranged vertically spaced apart from one another parallel to the axis of rotation of the sensor arrangement.

12. The scanning apparatus according to claim 1,
wherein
the sensor arrangement has an optical sensor element, with the sensor sections being configured as sections of the sensor element that are geometrically spaced apart from one another, or wherein the sensor arrangement has two geometrically separate optical sensor elements, with each sensor element comprising one of the sensor sections.

13. The scanning apparatus according to claim 1,
wherein
the sensor arrangement has a common sensor optics for the sensor sections, or
wherein the sensor arrangement has a separate sensor optics for each of the sensor sections.

14. The scanning apparatus according to claim 1,
wherein
the sensor sections are positioned at different sides of the axis of rotation.

15. A method for a spatial measurement of an environment by the scanning apparatus according to claim 1,
characterized in that
LiDAR data are acquired by the LiDAR sensor unit of the scanning apparatus and a spatial measurement of the environment is performed based on these LiDAR data, wherein optical environmental data of the environment are additionally acquired by the second sensor section of the scanning apparatus and stereo 3D data are determined by the evaluation unit of the scanning apparatus based on the LiDAR data and these additional environmental data of the second sensor section,
and wherein the measurement of the environment is improved by the evaluation unit by considering these stereo 3D data.

16. The scanning apparatus according to claim 2,
wherein the evaluation unit is configured to perform the improvement only, if a signal strength of the reception light and/or a ratio of a measurement signal to the noise of the reception light in the reception unit of the LiDAR sensor unit falls below a predetermined threshold value, and/or
if a signal strength of the reception light in the reception unit of the LiDAR sensor unit exceeds a predetermined threshold value, and/or
if a LiDAR distance determined by the LiDAR sensor unit and/or a stereo distance included in the stereo 3D data falls/fall below a predetermined distance threshold value.

17. The scanning apparatus according to claim 3,
wherein respective viewing directions of the two sensor sections, along which the respective sensor section is sensitive, include an angle Δα between 15° and 45°.

18. The scanning apparatus according to claim 4,
wherein the viewing directions of both sensor sections are oriented transversely to the axis of rotation.

19. The scanning apparatus according to claim 6,
wherein the output image corresponds to the measurement of the environment that is improved by the determined stereo 3D data.

20. The scanning apparatus according to claim 9,
wherein the longitudinal extent of the respective column is aligned parallel to the axis of rotation of the sensor arrangement.

21. The scanning apparatus according to claim 1,
wherein the sensor sections are positioned symmetrically with respect to the axis of rotation.
